(19) United States
(12) Patent Application Publication
(10) Pub. No.: US 2026/0012252 A1
(43) Pub. Date: Jan. 8, 2026

(54) METHOD AND SYSTEM FOR DYNAMIC ROUTING AND USER MOBILITY MANAGEMENT OF LOW-EARTH ORBIT SATELLITE CONSTELLATION

(71) Applicant: Hailong Su, Shanghai (CN)

(72) Inventor: Hailong Su, Shanghai (CN)

(21) Appl. No.: 19/327,014

(22) Filed: Sep. 12, 2025

(30) Foreign Application Priority Data
Aug. 27, 2025 (CN) 202511209407.X

(51) Int. Cl. H04B 7/185; H04B 10/25

(52) U.S. Cl. CPC H04B 7/18519; H04B 7/18508; H04B 7/18532; H04B 10/25

(57) ABSTRACT

A method and a system for dynamic routing and user mobility management of a low-earth orbit satellite constellation are provided, belonging to the technical field of satellite communication. The method includes the following steps: S1, reporting feeder link real-time state information; S2, storing and managing the feeder link real-time state information; S3, selecting an egress gateway station; S4, searching for a shortest delay path from an ingress satellite to the egress gateway station through an improved A* search algorithm; S5, extracting key forwarding nodes, encapsulating the key forwarding nodes into an outbound ticket and a return ticket, and issuing the outbound ticket and the return ticket to the egress gateway station and the ingress satellite. The method ignores the state of an inter-satellite link and a user link with a high-frequency jitter, and only takes a dynamic change of a feeder link as a trigger condition of path recalculation.

### TECHNICAL FIELD

The present disclosure belongs to the technical field of satellite communication, and in particular, relates to a method and a system for dynamic routing and user mobility management of a low-earth orbit satellite constellation.

### BACKGROUND

A super-large-scale low-earth orbit satellite constellation refers to a space system, which is deployed in a low-earth orbit and forms a collaborative network through technologies such as inter-satellite links and cluster control by using hundreds of satellites to achieve global wide-area coverage and provide services including communication, remote sensing, and navigation enhancement.

At present, there are the following problems in the communication of the super-large-scale low-earth orbit satellite constellation.

1. The satellite orbits the earth approximately every 90 minutes, and the link changes frequently, which is easy to trigger path recalculation, leads to frequent network rerouting, and reduces path stability.

2. Even with inter-satellite links and on-board routing capability, an existing static ground network access point model cannot adapt to the network dynamics, which easily results in connection fluctuation and flow interruption.

3. A user terminal needs to frequently switch the satellites that the user terminal accesses. Such a frequent link handover severely affects the Transmission Control Protocol (TCP) performance. It is difficult for an existing mobility protocol to effectively deal with this problem.

4. Due to the lack of a gateway station in a remote area, it is difficult to continuously connect to a ground network access point, and it is impossible to achieve real global services.

In view of this, a method and a system for dynamic routing and user mobility management of a low-earth orbit satellite constellation are designed to solve the above problems.

### SUMMARY

The present disclosure provides a method and a system for dynamic routing and user mobility management of a low-earth orbit satellite constellation, which have the characteristics of solving the problems raised in the foregoing background.

In order to achieve the foregoing objective, the present disclosure provides the following technical solution. A method for dynamic routing and user mobility management of a low-earth orbit satellite constellation includes the following steps:
S1, each gateway station periodically reporting feeder link real-time state information through a ground optical cable or submarine optical cable;
S2, a feeder link state database of a global ticketing arbiter storing and managing the reported feeder link real-time state information;
S3, the global ticketing arbiter selecting an egress gateway station according to the feeder link real-time state information in the feeder link state database;
S4, the global ticketing arbiter searching for a shortest delay path from an ingress satellite to the egress gateway station through an improved A* search algorithm with an optimization goal of minimizing an end-to-end delay on the premise of avoiding a congested path or an expected disconnected link area according to the feeder link real-time state information in the feeder link state database;
S5, a global ticketing arbiter control center extracting a set of key forwarding nodes from the searched shortest delay path, encapsulating the key forwarding nodes into an outbound ticket and a return ticket, and issuing the outbound ticket and the return ticket to the egress gateway station and the ingress satellite; and
S6, the ingress satellite and the egress gateway station performing uplink and downlink communication through the outbound ticket and the return ticket that are encapsulated.

Further, a specific step of Step S1 includes:
when the feeder link state between the gateway station and the satellite changes, the gateway station sending a state report of the feeder link to the global ticketing arbiter control center through a ground optical cable or submarine optical cable; where
the change of the feeder link state includes the fact that a feeder link is newly established or the feeder link is about to be disconnected; and
the state report includes a unique identifier of the gateway station, a list of currently connected satellite Ids, the establishment time of each feeder link, and the expected failure time of each feeder link.

Further, specific steps of Step S2 include:
after receiving the state report of the feeder link, the global ticketing arbiter control center writing each feeder link as an independent entity into the feeder link state database;
the feeder link state database storing the state report of the feeder link, including: the establishment time and the expected failure time of the feeder link;
a satellite identifier currently bound to the feeder link;
a globally unique identifier of the feeder link, that is, the gateway station ID and the feeder link ID;
a scheduling frequency and a historical usage record of the feeder link; and
a mapping relationship between the ingress satellite and the egress gateway station of the feeder link;
the feeder link state database managing the state report of the feeder link, including:
in the case of a newly established feeder link, creating an entry and initializing a scheduling count to zero;
in the case of a failed feeder link, deleting and releasing relevant allocated tickets in time, and calculating new tickets; and
updating the state of all feeder links in real time with a timestamp as an index.

Further, specific steps of Step S3 include:
after receiving a request from the ingress satellite, the global ticketing arbiter control center locating a nearest ground network access point according to a current position of the ingress satellite;
the global ticketing arbiter connecting all the gateway stations within a range of 1000 km with the nearest ground network access point as the center;
the global ticketing arbiter control center calculating a valid period of a ticket of a path between the nearest ground network access point and the connected multiple gateway stations, respectively;
the global ticketing arbiter control center taking the gateway station with the longest valid period of the ticket of the path connected by the nearest ground network access point as the egress gateway station of the ticket; and
storing a mapping relationship between the ingress satellite and the selected egress gateway station in the feeder link state database.

Further, specific steps of Step S4 include:
according to the feeder link real-time state information in the feeder link state database, the global ticketing arbiter control center calling the improved A* search algorithm to calculate the shortest delay path between the ingress satellite and the egress gateway station;
defining a path cost function as:

$$f ( n ) = g ( n ) + h ( n )$$

where g(n) denotes a cumulative path cost from the ingress satellite to the current node; h(n) denotes an estimated distance from the current node to the egress gateway station;
adding a load penalty factor in g(n), that is, when the load of the node is high, increasing the cost to avoid the congested path or the expected disconnected link area; and
introducing a scheduling penalty factor into the path cost function at the same time:

$${g}^{′} = d \cdot {( 1 + α )}^{n}$$

where d denotes the distance of the edge of the feeder link visited by the current A* algorithm; n denotes the number of times that the feeder link is currently used by the ticket;
and a denotes a scheduling sensitivity factor.

Further, specific steps of Step S5 include:
the global ticketing arbiter control center extracting a set of key forwarding nodes from the searched shortest delay path, including relay gateway stations, two relay satellites connected with each relay gateway station, and the selected egress gateway station to form a key relay node sequence;
encapsulating the key forwarding nodes into tickets, including an outbound ticket and a return ticket;
the outbound ticket including the key relay node sequence arranged in a path order and the validity time of the feeder link;
the return ticket including the key relay node sequence arranged in a reverse path order and the validity time of the feeder link;
storing the number of scheduling times of the feeder link used in the encapsulating process into the feeder link state database, and updating the number of scheduling times and the historical usage record of the feeder link in the feeder link state database;
if a feeder link in the ticket is about to fail, or the path has exceeded the valid period of the ticket, the global ticketing arbiter control center refreshing the ticket two seconds in advance, completing the replacement before the feeder link is actually disconnected, and storing the ticket in the feeder link state database;
storing the encapsulated ticket into a dynamic ticket queue;
pre-allocating tickets in the dynamic ticket queue through an on-demand pre-allocation or global pre-allocation strategy;
the on-demand allocation indicating that the global ticketing arbiter control center pre-allocates a ticket to the satellite that is about to serve a high-demand area according to satellite transit prediction and regional traffic popularity;
the global pre-allocation being enabled on the premise that deployment resources gives permission, that is, all satellites holding at least one valid ticket to achieve instant connection and use anywhere in the world at any time; and
the global ticketing arbiter control center sending the outbound ticket to a target gateway station in a unicast transmission mode through a Transmission Control Protocol (TCP) according to a pre-allocation result of the ticket, the target gateway station forwarding the outbound ticket to a target ingress satellite according to the return ticket, and after both the ingress satellite and the egress gateway station send a confirmation response, considering the ticket allocation to be completed, otherwise, a timeout mechanism performing automatic retry.

Further, specific steps of Step S6 include:

uplink communication, including:
when a user terminal accesses the network through a user link and sends data, after receiving a user data packet, the ingress satellite looking up the outbound ticket issued in advance by the global ticketing arbiter control center in the local cache, and encapsulating the outbound ticket as path information into a Header of the data packet;
the encapsulating content including a target ground network access point identifier, an egress gateway station identifier, a key relay node sequence, a current relay step count, and a valid timestamp;
when the satellite or the gateway station receives a data packet containing a ticket, parsing a ticket structure in the Header, obtaining information of “a next hop node”, and checking whether the current node is the “current forwarding node” in the ticket, if so, continuing to look up a next relay node and forwarding the next relay node, if the next hop node is unreachable, directly discarding the packet without any buffering or retry to prevent outdated path data from occupying network resources, if the current node is a relay gateway station, reading the current “step number field” from the current relay step count in the Header, increasing the value of the field by 1, re-encapsulating the updated Header into the data packet, continuing forwarding according to the next hop relay node, and if the current node is an egress gateway station, directly delivering the data to the ground network or the target ground network access point identifier; and
the situation that the next hop node is unreachable including the fact that the feeder link is disconnected and the next key node is also a satellite, but the satellite is in a different shell from the current satellite;
downlink communication, including:
a downlink data packet sent from the ground network to the user terminal, in which the ground network access point queries the return ticket corresponding to the user terminal when generating the data response, and encapsulating the return ticket as a Header to be attached to the data packet;
sending downlink data from the egress gateway station to the ingress satellite along the reverse path of the key node in the return ticket, and finally delivering the downlink data to the user terminal; and
in a process of uplink and downlink communication, the relay node skipping performing automatic path recovery or rerouting because the feeder link in the ticket fails or is unreachable, and the global ticketing arbiter control center judging whether it is necessary to redistribute a new ticket for a relevant ingress satellite in a subsequent scheduling cycle.

A system for dynamic routing and user mobility management of a low-earth orbit satellite constellation includes:
a feeder link information uploading module, where each gateway station periodically reports feeder link real-time state information through a ground optical cable or submarine optical cable;
a feeder link information storage module, where a feeder link state database of a global ticketing arbiter stores and manages the reported feeder link real-time state information;
an egress gateway station selection module, where the global ticketing arbiter selects an egress gateway station according to the feeder link real-time state information in the feeder link state database;
a shortest delay path searching module, where the global ticketing arbiter searches for a shortest delay path from an ingress satellite to the egress gateway station through an improved A* search algorithm with an optimization goal of minimizing an end-to-end delay on the premise of avoiding a congested path or an expected disconnected link area according to the feeder link real-time state information in the feeder link state database;
a ticket encapsulating and issuing module, where a global ticketing arbiter control center extracts a set of key forwarding nodes from the searched shortest delay path, encapsulates the key forwarding nodes into an outbound ticket and a return ticket, and issues the outbound ticket and the return ticket to the egress gateway station and the ingress satellite; and
an uplink and downlink communication module, where the ingress satellite and the egress gateway station perform uplink and downlink communication through the outbound ticket and the return ticket that are encapsulated.

Compared with the prior art, the present disclosure has the following beneficial effects.

1. The present disclosure ignores the state of an inter-satellite link and a user link with a high-frequency jitter, and only takes a dynamic change of a feeder link as a trigger condition of path recalculation. Because the feature reduces a path switching frequency, frequent rerouting caused by a non-critical link jitter can be avoided, and path stability and overall network robustness can be significantly improved.

2. The global ticketing arbiter control center of the present disclosure uses the A* search algorithm to quickly search for the optimal path from the ingress satellite to the egress gateway station, and issues a key relay node to a network edge node in combination with a “ticket mechanism”, which can avoid the delay caused by the local calculation path of the satellite node, quickly respond to the link change, and improve the path deployment efficiency and the data forwarding speed. However, forwarding is distributed forwarding based on a ticket, which is therefore compatible with all current single-shell inter-satellite routing and provides room for adaptive inter-satellite routing to play its role.

3. The present disclosure improves the A* search algorithm, and introduces a link scheduling penalty factor into a path cost function, so that the path cost can be weighted and adjusted according to the number of times the link is currently scheduled, and the overuse of a single feeder link can be effectively controlled. This mechanism can dynamically guide traffic to avoid congested links, achieve the dynamic balanced allocation of the link load, reduce the risk of hot-spot bottlenecks, and improve the utilization rate of link resources.

4. There are two types of ticket pre-allocation in the present disclosure. One type of ticket pre-allocation is the on-demand ticket pre-allocation based on regional demand prediction, and the other type of ticket pre-allocation is the global ticket pre-allocation based on global service coverage, which can ensure that there is an available path when the user terminal accesses for the first time, and improve the network access timeliness and service coverage integrity.

5. The present disclosure issues and confirms the ticket through a TCP unicast protocol, and sets the unique ID and the confirmation mechanism of the ticket, so as to ensure reliable delivery and avoid repeated broadcasting, effectively control the bandwidth consumption of control signaling, and keep good scalability and communication efficiency even in a large-scale constellation.

6. The key relay node in the path ticket of the present disclosure remain fixed within the valid period, and the data packet loss caused by path failure is avoided through a pre-refreshing mechanism, so that the consistency of forwarding paths can be ensured, and communication interruption caused by sudden link failure can be avoided. This is suitable for services with high continuity requirements such as video and voice.

7. In the present disclosure, the ground gateway station is responsible for global scheduling and path allocation, while the on-board node and the relay gateway station only need to forward data according to the ticket, without maintaining the topological state by themselves or running complex routing protocols. This can reduce the processing burden on the satellite side, improve the utilization rate of on-board resources, and provide convenience for compatible deployment among heterogeneous constellations of a plurality of manufacturers.

### BRIEF DESCRIPTION OF THE DRAWINGS

FIG. 1 is a schematic diagram of a basic principle of a global ticketing arbiter according to the present disclosure;

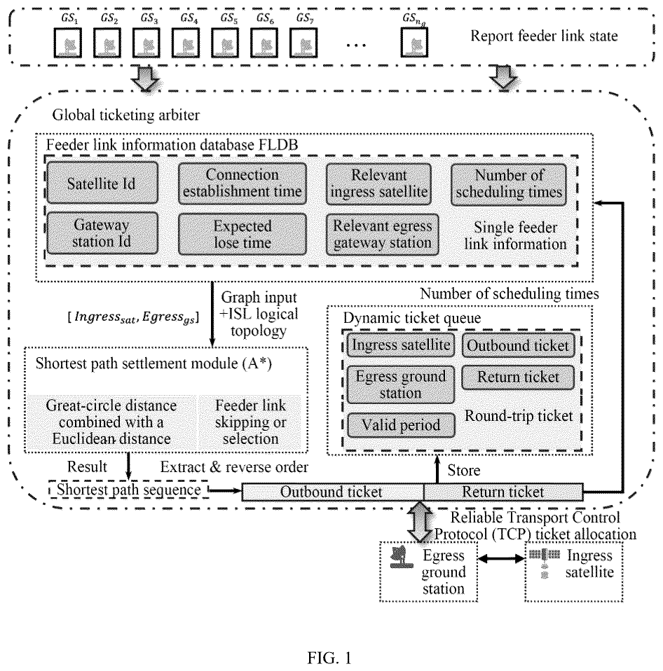

FIG. 2 is a schematic diagram of a data forwarding plane under the guidance of a global ticketing arbiter according to the present disclosure; and

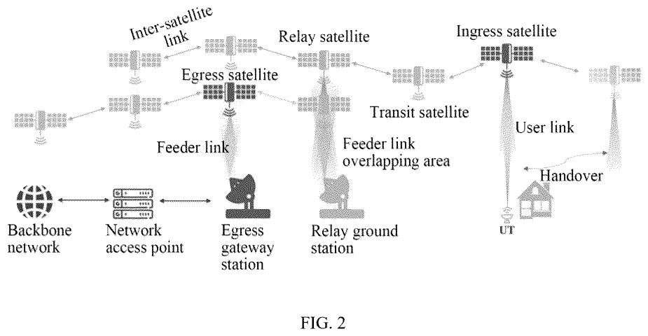

FIG. 3 is a schematic diagram of a module according to the present disclosure.

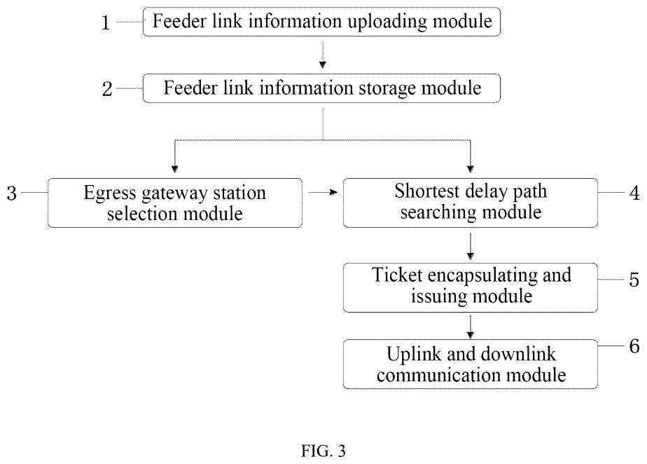

In the drawing: 1. Feeder link information uploading module; 2. Feeder link information storage module; 3. Egress gateway station selection module; 4. Shortest delay path searching module; 5. Ticket encapsulating and issuing module; 6. Uplink and downlink communication module.

### DETAILED DESCRIPTION OF THE EMBODIMENTS

The technical solution in the embodiment of the present disclosure will be clearly and completely described with reference to the attached drawings below. Obviously, the described embodiments are only some of the embodiments of the present disclosure, rather than all of the embodiments. Based on the embodiments in the present disclosure, all other embodiments obtained by those skilled in the art without paying creative labor belong to the scope of protection of the present disclosure.

The present disclosure provides the following technical solution. A method for dynamic routing and user mobility management for a low-earth orbit satellite constellation includes the following steps.
S1, each gateway station GS periodically reports feeder link FL real-time state information through a ground optical cable or submarine optical cable.
S2, a feeder link state database FLDB of a global ticketing arbiter GTA stores and manages the reported feeder link FL real-time state information.
S3, the global ticketing arbiter GTA selects an egress gateway station GS according to the feeder link FL real-time state information in the feeder link state database FLDB.
S4, the global ticketing arbiter GTA searches for a shortest delay path from an ingress satellite to the egress gateway station GS through an improved A* search algorithm with an optimization goal of minimizing an end-to-end delay on the premise of avoiding a congested path or an expected disconnected link area according to the feeder link FL real-time state information in the feeder link state database FLDB.
S5, a global ticketing arbiter GTA control center extracts a set of key forwarding nodes from the searched shortest delay path, encapsulates the key forwarding nodes into an outbound ticket and a return ticket, and issues the outbound ticket and the return ticket to the egress gateway station GS and the ingress satellite.
S6, the ingress satellite and the egress gateway station GS performs uplink and downlink communication through the outbound ticket and the return ticket that are encapsulated.

Specifically, a specific step of Step S1 is as follows.

When the feeder link state FL between the gateway station GS and the satellite changes, the gateway station GS sends a state report of the feeder link FL to the global ticketing arbiter GTA control center through a ground optical cable or submarine optical cable.

The change of the feeder link FL state includes the fact that a feeder link FL is newly established or the feeder link FL is about to be disconnected.

The state report includes a unique identifier of the gateway station GS, a list of currently connected satellite Ids, the establishment time of each feeder link FL, and the expected failure time of each feeder link FL.

The expected failure time of the feeder link FL is dynamically calculated locally by the gateway station GS based on ephemeris data and a real-time elevation angle.

Specifically, specific steps of Step S2 are as follows.

After receiving the state report of the feeder link FL, the global ticketing arbiter GTA control center writes each feeder link FL as an independent entity into the feeder link state database FLDB.

The feeder link state database FLDB stores the state report of the feeder link FL, including:
the establishment time and the expected failure time of the feeder link FL;
a satellite identifier currently bound to the feeder link FL;
a globally unique identifier of the feeder link FL, that is, the gateway station GS ID and the feeder link FL ID;
a scheduling frequency and a historical usage record of the feeder link FL; and
a mapping relationship between the ingress satellite and the egress gateway station GS of the feeder link FL.

The feeder link state database FLDB manages the state report of the feeder link FL, including:
in the case of a newly established feeder link FL, creating an entry and initializing a scheduling count to zero;
in the case of a failed feeder link FL, deleting and releasing relevant allocated tickets in time, and calculating new tickets; and
updating the state of all feeder links FL in real time with a timestamp as an index.

Specifically, specific steps of Step S3 are as follows.

After receiving a request from the ingress satellite, the global ticketing arbiter GTA control center locates a nearest ground network access point PoP according to a current position of the ingress satellite.

The global ticketing arbiter GTA connects all the gateway stations GS within a range of 1000 km with the nearest ground network access point POP as the center.

The global ticketing arbiter GTA control center calculates a valid period of a ticket of a path between the nearest ground network access point POP and the connected multiple gateway stations GS, respectively. The expression is:

$$VP = {min}_{i ∈ {𝒫}_{FL}} ( {ExpectedLossTime}_{i} - CurrentTime )$$

where [symbol] _{FL} denotes a set of all the feeder links FL passing through the path; ExpectedLossTimeᵢ denotes the expected failure time of ticket i; and CurrentTime denotes the current time.

ExpectedLossTimeᵢ is provided by the feeder link state database FLDB.

CurrentTime is provided by a timing system.

The global ticketing arbiter GTA control center takes the gateway station GS with the longest valid period of the ticket of the path connected by the nearest ground network access point POP as the egress gateway station GS of the ticket. The expression is:

$$Egress GS = arg {max}_{j ∈ 𝒢 ( PoP )} {VP}_{j}$$

where [symbol] (POP) denotes all gateway stations GS connected with the nearest ground network access point PoP.

A mapping relationship between the ingress satellite and the selected egress gateway station GS is stored in the feeder link state database FLDB.

This corresponds to “storage of the feeder link state database FLDB including: a mapping relationship between the ingress satellite and the egress gateway station GS of the feeder link FL” in S2.

Specifically, specific steps of Step S4 are as follows.

According to the feeder link FL real-time state information in the feeder link state database FLDB, the global ticketing arbiter GTA control center calls the improved A* search algorithm to calculate the shortest delay path between the ingress satellite and the egress gateway station GS.

A path cost function is defined as:

$$f ( n ) = g ( n ) + h ( n )$$

where g(n) denotes a cumulative path cost from the ingress satellite to the current node; h(n) denotes an estimated distance from the current node to the egress gateway station GS.

A load penalty factor is added in g(n), that is, when the load of the node is high, the cost is increased to avoid the congested path or the expected disconnected link area.

h(n) is calculated depending on whether there is earth occlusion. If there is line-of-sight occlusion between the egress gateway station GS and the currently visited node, a great-circle distance is used, and the radius of the circle is the radius of the earth. If there is no line-of-sight occlusion between the egress gateway station GS and the currently visited node, a Euclidean distance is used, that is, a linear distance.

In order to prevent a single feeder link FL from being overloaded, the global ticketing arbiter GTA control center introduces a scheduling penalty factor into the path cost function:

$${g}^{′} = d \cdot {( 1 + α )}^{n}$$

where d denotes the distance of the edge of the feeder link FL visited by the current A* algorithm; n denotes the number of times that the feeder link FL is currently used by the ticket; and a denotes a scheduling sensitivity factor.

The distance of d is the Euclidean distance.
n corresponds to the scheduling frequency of the feeder link FL, which is provided by the feeder link state database FLDB.
α is flexibly configured according to the regional priority, the service level or the service type.

For example, a higher a value can be used in a hot spot to disperse the pressure. A specific gateway station GS can reserve a feeder link FL resource with a high priority, and achieve service differentiation.

Specifically, specific steps of Step S5 are as follows.

The global ticketing arbiter GTA control center extracts a set of key forwarding nodes from the searched shortest delay path, including relay gateway stations GS, two relay satellite connected with each relay gateway station GS, and the selected egress gateway station GS to form a key relay node sequence.

The key forwarding nodes are encapsulated into tickets, including an outbound ticket and a return ticket.

The outbound ticket includes the key relay node sequence arranged in a path order and the validity time of the feeder link FL.

The return ticket includes the key relay node sequence arranged in a reverse path order and the validity time of the feeder link FL.

This corresponds to the “tickets” in S2 and S3.

The number of scheduling times of the feeder link FL used in the encapsulating process is stored into the feeder link state database FLDB, and the number of scheduling times and the historical usage record of the feeder link FL in the feeder link state database FLDB are updated.

This corresponds to “the scheduling frequency and the historical usage record of the feeder link FL” in S2.

If a feeder link FL in the ticket is about to fail, or the path has exceeded the valid period of the ticket, the global ticketing arbiter GTA control center refreshes the ticket two seconds in advance, completes the replacement before the feeder link FL is actually disconnected, and stores the ticket in the feeder link state database FLDB.

This corresponds to “in the case of a failed feeder link FL, deleting and releasing relevant allocated tickets in time, and calculating new tickets” in S2.

The encapsulated ticket is stored into a dynamic ticket queue.

Tickets in the dynamic ticket queue are pre-allocated through an on-demand pre-allocation or global pre-allocation strategy.

The on-demand allocation indicates that the global ticketing arbiter GTA control center pre-allocates a ticket to the satellite that is about to serve a high-demand area according to satellite transit prediction and regional traffic popularity.

The global pre-allocation is enabled on the premise that deployment resources gives permission, that is, all satellites hold at least one valid ticket to achieve instant connection and use anywhere in the world at any time.

The global ticketing arbiter GTA control center sends the outbound ticket to a target gateway station GS in a unicast transmission mode through a Transmission Control Protocol (TCP) according to a pre-allocation result of the ticket. The target gateway station GS forwards the outbound ticket to a target ingress satellite according to the return ticket. After both the ingress satellite and the egress gateway station send a confirmation response, the ticket allocation is considered to be completed, otherwise, a timeout mechanism performs automatic retry.

Specifically, specific steps of Step S6 are as follows.

Uplink communication includes:
when a user terminal UT accesses the network through a user link UL and sends data, after receiving a user data packet, the ingress satellite looking up the outbound ticket issued in advance by the global ticketing arbiter GTA control center in the local cache, and encapsulating the outbound ticket as path information into a Header of the data packet.

The encapsulating content includes a target ground network access point POP identifier, an egress gateway station GS identifier, a key relay node sequence, a current relay step count, and a valid timestamp.

When receiving a data packet containing a ticket, the satellite or the gateway station GS parses a ticket structure in the Header, obtains information of “a next hop node”, and checks whether the current node is the “current forwarding node” in the ticket. If so, the satellite or the gateway station continues to look up a next relay node and forwards the next relay node. If the next hop node is unreachable, the packet is directly discarded without any buffering or retry to prevent outdated path data from occupying network resources. If the current node is a relay gateway station GS, the current “step number field” is read from the current relay step count in the Header, the value of the field is increased by 1. The updated Header is re-encapsulated into the data packet. Continue forwarding according to the next hop relay node. If the current node is an egress gateway station GS, the data is directly delivered to the ground network or the target ground network access point POP identifier.

The situation that the next hop node is unreachable includes the fact that the feeder link FL is disconnected and the next key node is also a satellite, but the satellite is in a different shell from the current satellite.

Downlink communication includes:
a downlink data packet sent from the ground network to the user terminal UT, in which the ground network access point POP queries the return ticket corresponding to the user terminal UT when generating the data response, and encapsulates the return ticket as a Header to be attached to the data packet.

Downlink data is sent from the egress gateway station GS to the ingress satellite along the reverse path of the key node in the return ticket, and is finally delivered to the user terminal UT.

In a process of uplink and downlink communication, the relay node skips performing automatic path recovery or rerouting because the feeder link FL in the ticket fails or is unreachable, and the global ticketing arbiter GTA control center judges whether it is necessary to redistribute a new ticket for a relevant ingress satellite in a subsequent scheduling cycle.

A system for dynamic routing and user mobility management of a low-earth orbit satellite constellation includes:
a feeder link information uploading module 1, where each gateway station GS periodically reports feeder link FL real-time state information through a ground optical cable or submarine optical cable;
a feeder link information storage module 2, where a feeder link state database FLDB of a global ticketing arbiter GTA stores and manages the reported feeder link FL real-time state information;
an egress gateway station selection module 3, where the global ticketing arbiter GTA selects an egress gateway station GS according to the feeder link FL real-time state information in the feeder link state database FLDB;
a shortest delay path searching module 4, where the global ticketing arbiter GTA searches for a shortest delay path from an ingress satellite to the egress gateway station GS through an improved A* search algorithm with an optimization goal of minimizing an end-to-end delay on the premise of avoiding a congested path or an expected disconnected link area according to the feeder link FL real-time state information in the feeder link state database FLDB;
a ticket encapsulating and issuing module 5, where a global ticketing arbiter GTA control center extracts a set of key forwarding nodes from the searched shortest delay path, encapsulates the key forwarding nodes into an outbound ticket and a return ticket, and issues the outbound ticket and the return ticket to the egress gateway station GS and the ingress satellite; and
an uplink and downlink communication module 6, where the ingress satellite and the egress gateway station GS perform uplink and downlink communication through the outbound ticket and the return ticket that are encapsulated.

Although embodiments of the present disclosure have been shown and described, it will be understood by those skilled in the art that various changes, modifications, substitutions and variations can be made to these embodiments without departing from the principle and the spirit of the present disclosure. The scope of the present disclosure is defined by the appended claims and their equivalents.

What is claimed is:

1. A method for dynamic routing and user mobility management of a low-earth orbit satellite constellation, comprising the following steps:
S1, periodically reporting, by each gateway station, feeder link real-time state information through a ground optical cable or submarine optical cable;
S2, storing and managing, by a feeder link state database of a global ticketing arbiter, the reported feeder link real-time state information;
S3, selecting, by the global ticketing arbiter, an egress gateway station according to the feeder link real-time state information in the feeder link state database;
S4, searching, by the global ticketing arbiter, for a shortest delay path from an ingress satellite to the egress gateway station through an improved A* search algorithm with an optimization goal of minimizing an end-to-end delay on the premise of avoiding a congested path or an expected disconnected link area according to the feeder link real-time state information in the feeder link state database;
S5, extracting, by a global ticketing arbiter control center, a set of key forwarding nodes from the searched shortest delay path, encapsulating the key forwarding nodes into an outbound ticket and a return ticket, and issuing the outbound ticket and the return ticket to the egress gateway station and the ingress satellite; and
S6, performing, by the ingress satellite and the egress gateway station, uplink and downlink communication through the outbound ticket and the return ticket that are encapsulated.

2. The method for dynamic routing and user mobility management of the low-earth orbit satellite constellation according to claim 1, wherein a specific step of Step S1 comprises:
when the feeder link state between the gateway station and the satellite changes, sending, by the gateway station, a state report of the feeder link to the global ticketing arbiter control center through a ground optical cable or submarine optical cable; wherein
the change of the feeder link state comprises the fact that a feeder link is newly established or the feeder link is about to be disconnected; and
the state report comprises a unique identifier of the gateway station, a list of currently connected satellite Ids, the establishment time of each feeder link, and the expected failure time of each feeder link.

3. The method for dynamic routing and user mobility management of the low-earth orbit satellite constellation according to claim 2, wherein specific steps of Step S2 comprise:
after receiving the state report of the feeder link, writing, by the global ticketing arbiter control center, each feeder link as an independent entity into the feeder link state database;
storing, by the feeder link state database, the state report of the feeder link, comprising:
the establishment time and the expected failure time of the feeder link;
a satellite identifier currently bound to the feeder link;
a globally unique identifier of the feeder link, that is, the gateway station ID and the feeder link ID;
a scheduling frequency and a historical usage record of the feeder link; and
a mapping relationship between the ingress satellite and the egress gateway station of the feeder link;
managing, by the feeder link state database, the state report of the feeder link, comprising:
in the case of a newly established feeder link, creating an entry and initializing a scheduling count to zero;
in the case of a failed feeder link, deleting and releasing relevant allocated tickets in time, and calculating new tickets; and
updating the state of all feeder links in real time with a timestamp as an index.

4. The method for dynamic routing and user mobility management of the low-earth orbit satellite constellation according to claim 3, wherein specific steps of Step S3 comprises:
after receiving a request from the ingress satellite, locating, by the global ticketing arbiter control center, a nearest ground network access point according to a current position of the ingress satellite;
connecting, by the global ticketing arbiter, all the gateway stations within a range of 1000 km with the nearest ground network access point as the center;
calculating, by the global ticketing arbiter control center, a valid period of a ticket of a path between the nearest ground network access point and the connected multiple gateway stations, respectively;
taking, by the global ticketing arbiter control center, the gateway station with the longest valid period of the ticket of the path connected by the nearest ground network access point as the egress gateway station of the ticket; and
storing a mapping relationship between the ingress satellite and the selected egress gateway station in the feeder link state database.

5. The method for dynamic routing and user mobility management of the low-earth orbit satellite constellation according to claim 4, wherein specific steps of Step S4 comprise:
according to the feeder link real-time state information in the feeder link state database, calling, by the global ticketing arbiter control center, the improved A* search algorithm to calculate the shortest delay path between the ingress satellite and the egress gateway station;
defining a path cost function as:
$$f ( n ) = g ( n ) + h ( n )$$
where g(n) denotes a cumulative path cost from the ingress satellite to the current node; h(n) denotes an estimated distance from the current node to the egress gateway station;
adding a load penalty factor in g(n), that is, when the load of the node is high, increasing the cost to avoid the congested path or the expected disconnected link area; and
introducing a scheduling penalty factor into the path cost function at the same time:
$${g}^{′} = d \cdot {( 1 + α )}^{n}$$
where d denotes the distance of the edge of the feeder link visited by the current A* algorithm; n denotes the number of times that the feeder link is currently used by the ticket;
and a denotes a scheduling sensitivity factor.

6. The method for dynamic routing and user mobility management of the low-earth orbit satellite constellation according to claim 5, wherein specific steps of Step S5 comprise:
extracting, by the global ticketing arbiter control center, a set of key forwarding nodes from the searched shortest delay path, comprising relay gateway stations, two relay satellites connected with each relay gateway station, and the selected egress gateway station to form a key relay node sequence;
encapsulating the key forwarding nodes into tickets, comprising an outbound ticket and a return ticket;
the outbound ticket comprising the key relay node sequence arranged in a path order and the validity time of the feeder link;
the return ticket comprising the key relay node sequence arranged in a reverse path order and the validity time of the feeder link;
storing the number of scheduling times of the feeder link used in the encapsulating process into the feeder link state database, and updating the number of scheduling times and the historical usage record of the feeder link in the feeder link state database;
if a feeder link in the ticket is about to fail, or the path has exceeded the valid period of the ticket, refreshing, by the global ticketing arbiter control center, the ticket two seconds in advance, completing the replacement before the feeder link is actually disconnected, and storing the ticket in the feeder link state database;
storing the encapsulated ticket into a dynamic ticket queue;
pre-allocating tickets in the dynamic ticket queue through an on-demand pre-allocation or global pre-allocation strategy;
the on-demand allocation indicating that the global ticketing arbiter control center pre-allocates a ticket to the satellite that is about to serve a high-demand area according to satellite transit prediction and regional traffic popularity;
the global pre-allocation being enabled on the premise that deployment resources gives permission, that is, all satellites holding at least one valid ticket to achieve instant connection and use anywhere in the world at any time; and
sending, by the global ticketing arbiter control center, the outbound ticket to a target gateway station in a unicast transmission mode through a Transmission Control Protocol (TCP) according to a pre-allocation result of the ticket, forwarding, by the target gateway station, the outbound ticket to a target ingress satellite according to the return ticket, and after both the ingress satellite and the egress gateway station send a confirmation response, considering the ticket allocation to be completed, otherwise, performing, by a timeout mechanism, automatic retry.

7. The method for dynamic routing and user mobility management of the low-earth orbit satellite constellation according to claim 6, wherein specific steps of Step S6 comprise:
uplink communication, comprising:
when a user terminal accesses the network through a user link and sends data, after receiving a user data packet, looking up, by the ingress satellite, the outbound ticket issued in advance by the global ticketing arbiter control center in the local cache, and encapsulating the outbound ticket as path information into a Header of the data packet;
the encapsulating content comprising a target ground network access point identifier, an egress gateway station identifier, a key relay node sequence, a current relay step count, and a valid timestamp;
when the satellite or the gateway station receives a data packet containing a ticket, parsing a ticket structure in the Header, obtaining information of “a next hop node”, and checking whether the current node is the “current forwarding node” in the ticket, if so, continuing to look up a next relay node and forwarding the next relay node, if the next hop node is unreachable, directly discarding the packet without any buffering or retry to prevent outdated path data from occupying network resources, if the current node is a relay gateway station, reading the current “step number field” from the current relay step count in the Header, increasing the value of the field by 1, re-encapsulating the updated Header into the data packet, continuing forwarding according to the next hop relay node, and if the current node is an egress gateway station, directly delivering the data to the ground network or the target ground network access point identifier; and
the situation that the next hop node is unreachable comprising the fact that the feeder link is disconnected and the next key node is also a satellite, but the satellite is in a different shell from the current satellite;
downlink communication, comprising:
a downlink data packet sent from the ground network to the user terminal, in which the ground network access point queries the return ticket corresponding to the user terminal when generating the data response, and encapsulating the return ticket as a Header to be attached to the data packet;
sending downlink data from the egress gateway station to the ingress satellite along the reverse path of the key node in the return ticket, and finally delivering the downlink data to the user terminal; and
in a process of uplink and downlink communication, skipping, by the relay node, performing automatic path recovery or rerouting because the feeder link in the ticket fails or is unreachable, and judging, by the global ticketing arbiter control center, whether it is necessary to redistribute a new ticket for a relevant ingress satellite in a subsequent scheduling cycle.

8. A system for dynamic routing and user mobility management of a low-earth orbit satellite constellation according to the method for dynamic routing and user mobility management of the low-earth orbit satellite constellation according to claim 7, comprising:
a feeder link information uploading module (1), wherein each gateway station periodically reports feeder link real-time state information through a ground optical cable or submarine optical cable;
a feeder link information storage module (2), wherein a feeder link state database of a global ticketing arbiter stores and manages the reported feeder link real-time state information;
an egress gateway station selection module (3), wherein the global ticketing arbiter selects an egress gateway station according to the feeder link real-time state information in the feeder link state database;
a shortest delay path searching module (4), wherein the global ticketing arbiter searches for a shortest delay path from an ingress satellite to the egress gateway station through an improved A* search algorithm with an optimization goal of minimizing an end-to-end delay on the premise of avoiding a congested path or an expected disconnected link area according to the feeder link real-time state information in the feeder link state database;
a ticket encapsulating and issuing module (5), wherein a global ticketing arbiter control center extracts a set of key forwarding nodes from the searched shortest delay path, encapsulates the key forwarding nodes into an outbound ticket and a return ticket, and issues the outbound ticket and the return ticket to the egress gateway station and the ingress satellite; and
an uplink and downlink communication module (6), wherein the ingress satellite and the egress gateway station perform uplink and downlink communication through the outbound ticket and the return ticket that are encapsulated.
